(19) United States
(12) Patent Application Publication
(10) Pub. No.: US 2026/0225509 A1
(43) Pub. Date: Aug. 6, 2026

(54) VEHICLE ARMREST

(71) Applicant: Tesla, Inc., Austin, TX (US)

(72) Inventors: Sandeep Khengare, Fremont, CA (US); Shreyash Joshi, Fremont, CA (US); Nathan DiGusto, Fremont, CA (US)

(21) Appl. No.: 19/121,693

(22) PCT Filed: Oct. 11, 2023
(86) PCT No.: PCT/US2023/034896

§ 371 Date: Apr. 16, 2025

Related U.S. Application Data
(60) Provisional application No. 63/417,256, filed on Oct. 18, 2022.

(51) Int. Cl. B60N 2/75

(52) U.S. Cl. CPC B60N 2/793; B60N 2/757

(57) ABSTRACT

A vehicle armrest assembly can be equipped with functionalities such as providing storage and device charging. The armrest assembly can also include wing covers configured to conceal bracket and pivots around which the armrest rotates. The armrest assembly can further include a locking system to lock the armrest in a stowed position and prevent unexpected movement of the armrest from the stowed position to a fold-down position.

WO

### CROSS-REFERENCE TO RELATED APPLICATIONS

This application claims priority to U.S. Provisional Patent Application No. 63/417,256, filed Oct. 18, 2022, the entire content of which is incorporated by reference in its entirety and for all purposes.

### TECHNICAL FIELD

The present application relates to a vehicle armrest.

### BACKGROUND

Many vehicle armrests are designed with limited functionalities and exposed pivots and cutouts. It is desirable to provide additional functionalities, such as providing storage and device charging, with armrests. There also remains a need for movement control of vehicle armrests so that armrests do not move unexpectedly during sudden stops or impacts.

### SUMMARY

The disclosure relates generally to a vehicle armrest.

An aspect is directed to an armrest assembly of a vehicle. The armrest assembly includes a console configured to be positioned between two neighboring vehicle seats and rotatable about two pivots between a stowed position and a fold-down position. The armrest assembly further includes two wing covers configured to conceal the two pivots from a top side and a front side of the vehicle seats, the two wing covers being positioned between the console and the vehicle seats. The armrest assembly also includes a charging station configured to receive and charge one or more electrical devices, the charging station being positioned on a top side of the console.

A variation of the aspect above is the armrest assembly further includes a locking system, the locking system having one or more locking pins and an actuator assembly. The actuator assembly is configured to move the one or more locking pins between a locked configuration and an unlocked configuration when the console is in the stowed position. The console is locked in the stowed position when in the locked configuration, and the console is movable between the stowed position and the fold-down position when in the unlocked configuration.

A variation of the aspect above is the armrest assembly further includes a release button configured for a user to unlock the console when the console is in the stowed position.

A variation of the aspect above is the armrest assembly further includes a storage compartment and a storage lid configured to cover at least a portion of the storage compartment.

A variation of the aspect above is, wherein the storage lid is releasably latched to the console.

A variation of the aspect above is the armrest assembly further includes one or more cupholders positioned on the console.

A variation of the aspect above is the armrest assembly further includes an elastic gap hider configured to conceal the locking system from the top side and the front side of the vehicle seats.

A variation of the aspect above is, wherein the charging station comprises a charging tray positioned on the console and an induction charger unit disposed underneath the charging tray inside the console.

A variation of the aspect above is, wherein the two neighboring vehicle seats are positioned in a second row of the vehicle.

A variation of the aspect above is the armrest assembly further includes a bracket positioned on a back side of the armrest assembly, the two wing covers configured to conceal the bracket from a top side and a front side of the vehicle seats.

Another aspect of this disclosure is an armrest assembly of a vehicle, the armrest assembly including a console and two wing covers. The console is configured to be positioned between two neighboring vehicle seats and rotatable about two pivots between a stowed position and a fold-down position. The two wing covers are configured to at least partially conceal the two pivots.

A variation of the aspect above is, wherein each of the two wing covers comprises a lid configured to hide the pivot from a top side and a front side of the vehicle seats, and a cutout configured to allow the pivot to rotate within and relative to the cover.

A variation of the aspect above is the armrest assembly further includes a storage compartment disposed on the console.

A variation of the aspect above is the armrest assembly further includes a storage lid configured to cover at least a portion of the storage compartment and releasably latched to the console.

A variation of the aspect above is the armrest assembly further includes a bracket, the two wing covers configured to at least partially conceal the bracket.

Another aspect of this disclosure is an armrest assembly of a vehicle, the armrest assembly including a console and a charging station. The console is configured to be positioned between two neighboring vehicle seats and rotatable about two pivots between a stowed position and a fold-down position. The charging station is configured to receive and charge one or more electrical devices, the charging station being positioned on the console.

A variation of the aspect above is, wherein the charging station comprises a charging tray positioned on the console and an induction charger unit disposed underneath the charging tray inside the console.

Another aspect of this disclosure is an armrest assembly of a vehicle, the armrest assembly including a console and a locking system. The console is configured to be positioned between two neighboring vehicle seats and rotatable about two pivots between a stowed position and a fold-down position. The locking system includes one or more locking pins and an actuator assembly. The actuator assembly is configured to move the one or more locking pins between a locked configuration and an unlocked configuration when the console is in the stowed position. The console is locked in the stowed position when in the locked configuration, and the console is movable between the stowed position and the fold-down position when in the unlocked configuration.

A variation of the aspect above is the armrest assembly further includes a release button configured for a user to unlock the console when the console is in the stowed position.

A variation of the aspect above is the armrest assembly further includes an elastic gap hider configured to at least partially conceal the locking system.

### BRIEF DESCRIPTION OF THE DRAWINGS

The present disclosure is described with reference to the accompanying drawings, in which like reference characters reference like elements, and wherein:

FIG. 1A is a perspective view of an exemplary embodiment of an armrest assembly in both a fold-down position and a stowed position according to an embodiment of the present disclosure.

FIG. 1B is a perspective view of a trim of the armrest assembly in FIG. 1A.

FIG. 1C is a perspective view of a foam insert of the armrest assembly in FIG. 1A.

FIG. 1D is a perspective view of a substrate of the armrest assembly in FIG. 1A.

FIG. 1E is an illustration of the armrest assembly in FIG. 1A positioned between vehicle seats.

FIG. 2A is a cross-sectional close-up view of a first wing cover of the armrest assembly in FIG. 1A.

FIG. 2B is a perspective view of the first wing cover and a second wing cover of the armrest assembly in FIG. 1A.

FIG. 3A is a top plan view of another embodiment of an armrest assembly according to this disclosure.

FIG. 3B is a cross-sectional view of the armrest assembly in FIG. 3A taken along plane B-B.

FIG. 3C is a cross-sectional view of the armrest assembly in FIG. 3A taken along plane H-H.

FIG. 3D is a bottom plan view of the armrest assembly in FIG. 3A in a locked configuration.

FIG. 4A is a perspective view of an induction charger unit of the armrest assembly in FIG. 3A.

FIG. 4B is a perspective view of a charging station tray of the armrest assembly in FIG. 3A.

FIG. 5 is a perspective view of another embodiment of an armrest assembly according to this disclosure showing a storage lid in both a closed position and an open positioned.

FIG. 6A is a perspective view of a gap hider of an armrest assembly in a fold-down position.

FIG. 6B is a perspective view of the gap hider of the armrest assembly in a stowed position.

### DETAILED DESCRIPTION

Generally described, one or more aspects of the present disclosure relate to a vehicle armrest. In certain embodiments, this disclosure relates to advanced features of a second-row vehicle armrest. A conventional vehicle armrest may simply include trimmed foam connected to a vehicle seat via exposed free pivots. Embodiments of the armrest disclosed herein can include additional functionalities such as, for example, a locking mechanisms and phone chargers.

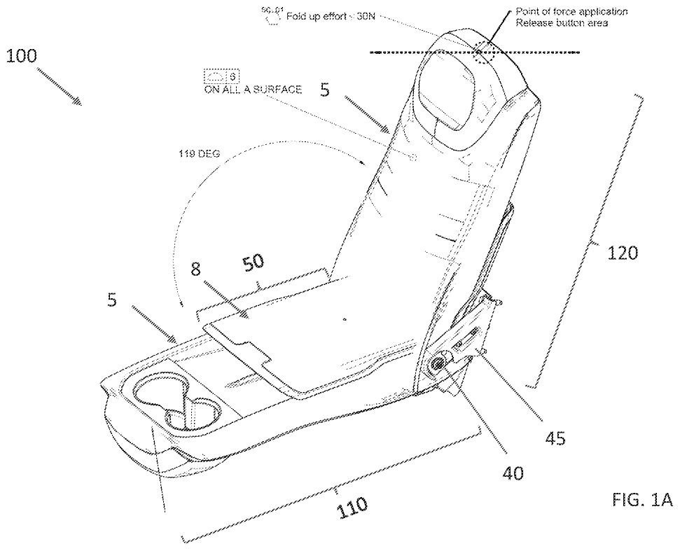

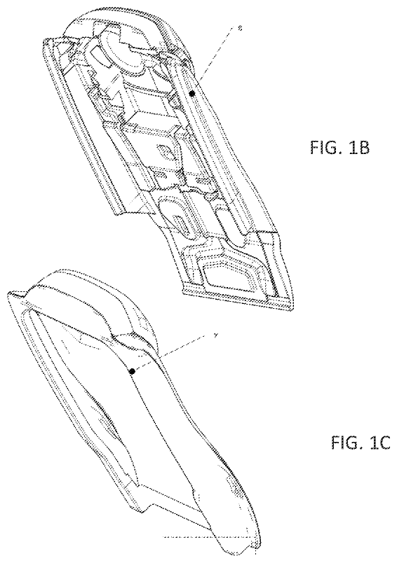

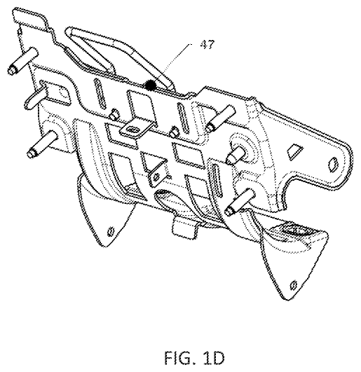

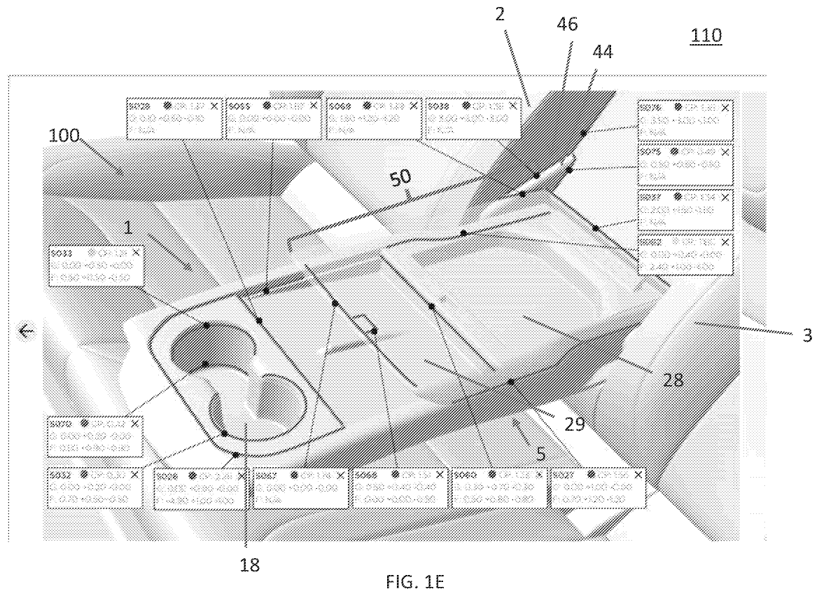

As shown in FIGS. 1A-1C, an armrest assembly 100 can include a console 5 having a foam insert 6 and a trim 7. In certain embodiments, the console 5 can include a pivot 40 positioned on each side of a first end of the console 5. In some embodiments, the armrest assembly can further include a bracket 47 (see FIG. 1D) positioned on a back side of the armrest assembly to provide support. In some embodiments, the pivots 40 can be configured to connect the armrest assembly 100 with neighboring vehicle seats 1 and 2 (see FIG. 1E) and/or a portion of a vehicle frame.

In various embodiments, the pivots 40 can be configured to be positioned between two neighboring vehicle seats 1 and 2. In some embodiments, the console 5 can be flush with the vehicle seats 1 and 2 when in a stowed position 120. When in use, the console 5 can be rotated around the pivots 40 to reach a fold-down position 110. In some embodiments, the console 5 can be substantially horizontal in the fold-down position 110. In some embodiments, the armrest assembly 100 can include a first wing cover 45 and a second wing cover 46 configured to cover the bracket 47 and/or exposed portions of the pivots 40 between the console 5 and the vehicle seats 1 and 2. As shown in FIG. 1E, when in the fold-down position 110, the wing cover 45 and 46 can be positioned in the gaps between the console 5 and the vehicle seats 1 and 2 to conceal the bracket 47 and/or the pivots 40 in both the stowed position 120 and the fold-down position 110.

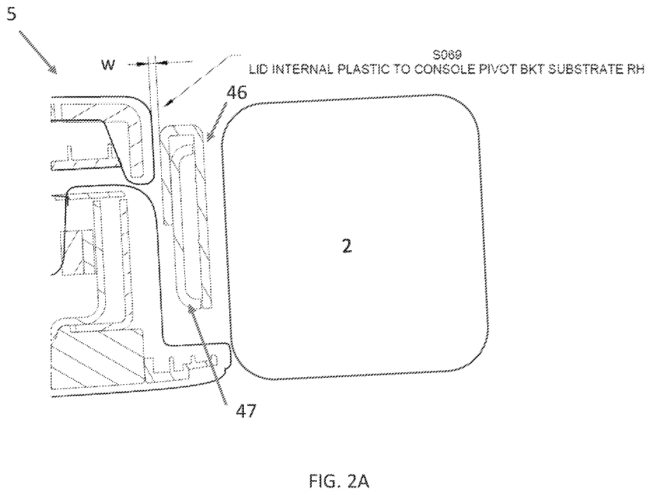

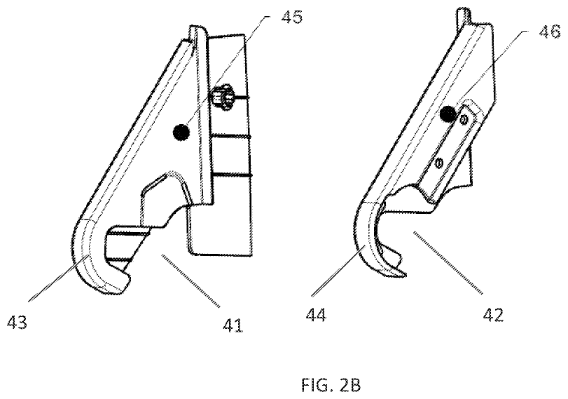

FIG. 2A is a cross-sectional view of an interaction between the console 5 and the wing cover 46 illustrating that the wing cover 46 can be positioned between the armrest console 5 and the vehicle seat 2. In some embodiments, there can be a gap having a width W between the console 5 and the wing cover 46. In some embodiments, the gap can have a width of 2 mm.

As shown in FIGS. 1E, 2B, and 3C, in some embodiments, the wing covers 45 and 46 can include hoods 43 and 44, respectively, to hide the bracket 47 and/or the pivots 40 from a top side and a front side of the vehicle seats 1 and 2. In some embodiments, the wing covers 45 and 46 can further include cutouts 41 and 42, respectively, to allow the pivots 40 to rotate within and relative to the wing covers 45 and 46.

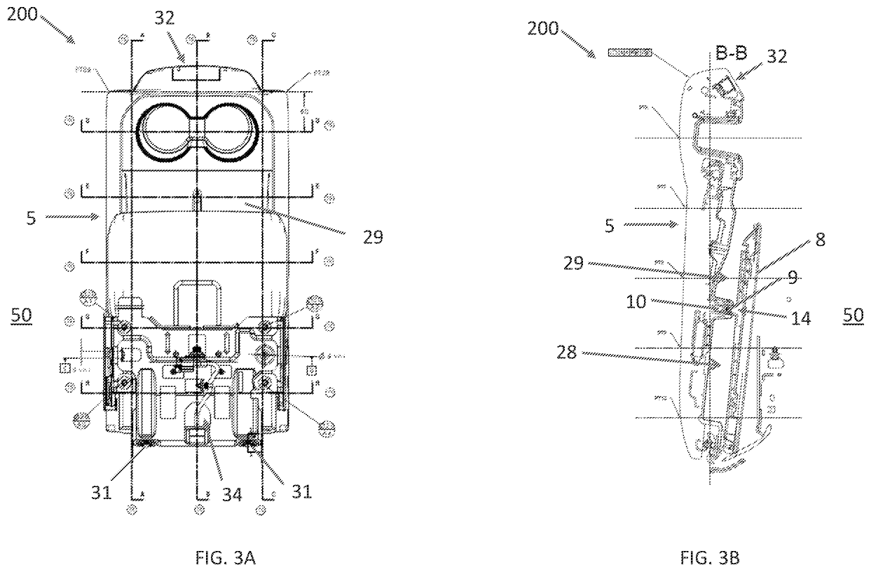

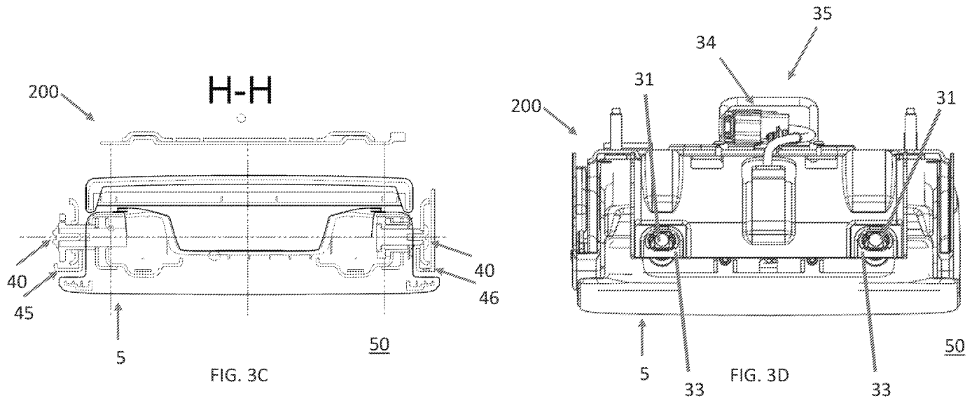

A vehicle armrest may move unexpectedly towards the fold-down position during crashes or when an object hits the armrest assembly from behind the vehicle seats. For example, a suitcase in a trunk of the vehicle may hit the vehicle seats from a back side during a sudden stop of the vehicle. In various embodiments, as shown in FIGS. 3A and 3D, an armrest assembly 200 can include a locking system 35. The locking system 35 can be configured to lock the console 5 in the stowed position 120 to prevent the armrest from unexpectedly rotating from the stowed position 120 to the fold-down position 110.

In some embodiments, the locking system 35 can include an actuator assembly 34 configured to lock the console 5 in the stowed position 120. In some embodiments, the locking system 35 can further include one or more locking pins 31 connected to the actuator assembly 34. In certain embodiments, the actuator assembly 34 is configured to selectively extend or retract the one or more locking pins to lock or unlock the console 5 in the stowed position 120. In some embodiments, the console 5 can include one or more pin brackets 33 (see FIG. 3D) configured to receive the one or more locking pins 31. In some embodiments, the one or more pin bracket 33 can be part of the bracket 47. In some embodiments, when the one or more locking pins 31 are extended and engaged with the one or more pin brackets 33 as shown in FIG. 3D, the armrest console is in a locked configuration. When the one or more locking pins 31 are retracted and not engaged with the one or more pin brackets 33, the armrest console is in an unlocked configuration. As shown in FIGS. 3A and 3D, the locking pins 31 can be in the form of spring plungers. In certain embodiments, the actuator assembly 34 connects to the spring plungers.

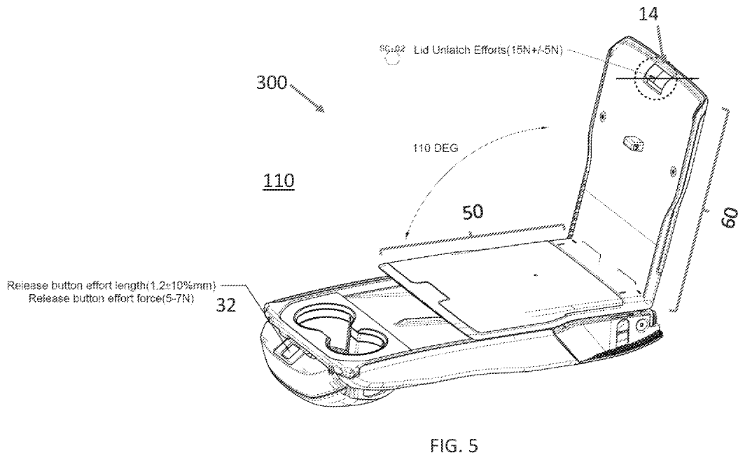

As shown in FIGS. 3A, 3B, and 5A, the locking system 35 can further include a release button 32 electrically connected to the actuator assembly 34 such that pressing the release button 32 can cause the actuator assembly 34 to unlock the console 5. In some embodiments, the release button 32 can be positioned on a top side of the console 5. In some embodiments, the top side faces a rear side of the vehicle when the console 5 is in the stowed position 120 to avoid accidental actuation of the release button 32. For example, when the console 5 is in the stowed position 120, a user can press the release button 32 to cause the actuator assembly 34 to retract the locking pins 31 from the pin brackets 33 such that the console 5 can be moved out of the stowed position 120 by an external force.

An armrest assembly according to this disclosure can also include functionalities such as providing storage and phone charging. As shown in FIG. 1E, the console 5 of the armrest assembly 100 can include a storage compartment 28. In some embodiments, the storage compartment 28 can be disposed proximate the first end of the console 5. The console 5 can further include one or more cupholders 18 disposed on a second end of the console 5, opposite to the first end.

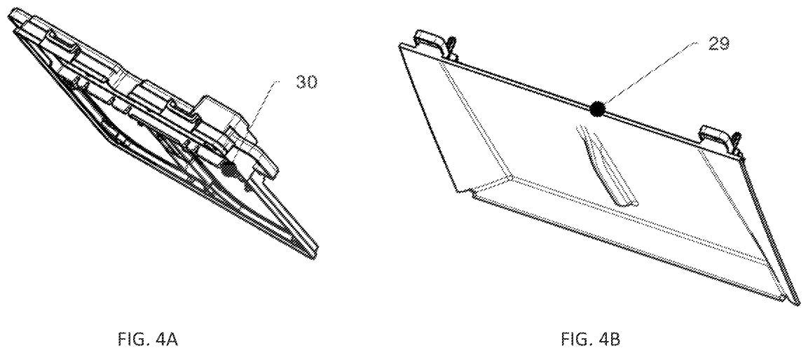

In some embodiments, the console 5 can further include a charging station configured to receive one or more electrical devices and provide power to the electrical devices. In certain embodiments, the charging station can include a charging tray 29 (see FIG. 4B) configured to receive and hold one or more electrical devices (e.g., mobile phones, tablets, electrical watches, etc.). In some embodiments, the charging tray 29 can be disposed on the top side of the console 5. In some embodiments, the charging station can include an induction charger unit 30 (see FIG. 4A) such that when a device capable of induction charging is placed on the charging tray 29, the induction charger unit 30 can provide power to the device. In some embodiments, the induction charger unit 30 can be coupled to the charging tray 29. The induction charger unit 30 can be disposed inside the console 5 underneath the charging tray 29. In some embodiments, the charging station can also include one or more charging ports disposed on the charging tray 29 to provide power by cable. In some embodiments, the charging station can be disposed in a central portion of the console 5.

In certain embodiments, the console 5 can further include a storage lid configured to cover the storage compartment in a closed position. In some embodiments, an armrest assembly 300 can include a storage lid 8 configured to be movable between a closed position 50 and an open position 60 as shown in FIG. 5 to enable convenient access to the storage compartment. In some embodiments, the storage lid 8 can also cover a portion of or the entire charging tray 29 to also provide coverage to the charging station.

In some embodiments, the storage lid 8 can also include a latching assembly 14 configured to releasably secure the storage lid 8 in the closed position 50. The latching assembly 14 can prevent sudden movements of the storage lid 8 caused by external forces. As shown in FIG. 3B, the latching assembly 14 can include a latching mechanism 9 disposed on a bottom side of the storage lid 8. The latching mechanism 9 can be configured to engage with a notch 10 disposed on the top side of the console 5. In some embodiments, the notch 10 can be positioned between the storage compartment 28 and the charging station.

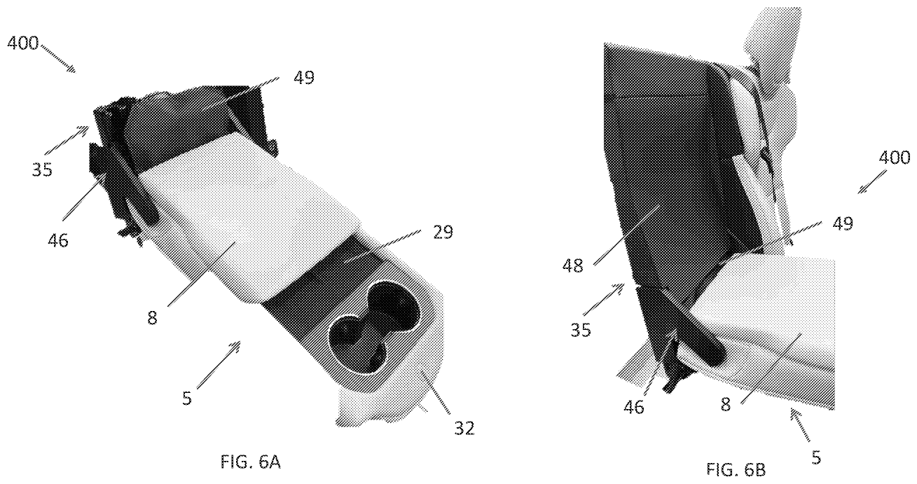

Finally, as shown in FIG. 6A, an armrest assembly 400 disclosed herein can further include a gap hider 49 configured to hide brackets, components of the locking system 35, and/or other components from view when the console 5 is in the fold-down position 110. In some embodiments, the gap hider 49 can include an elastic portion to allow the gap hider 49 to move (e.g., extend and/or contract) with the armrest console 5 between the fold-down position 110 and the stowed position 120 (see FIG. 6B). In some embodiments, the gap hider 49 can be made of a fabric material. In some embodiments, the gap hider 49 may be connected to the armrest console 5 on one end. In some embodiments, the gap hider 49 may be connected to a portion of a vehicle frame on the other end. In some embodiments, the gap hider 49 may be at least partially hidden behind a vehicle seat back panel 48.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including,” “comprising,” “incorporating,” “consisting of,” “have,” “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first,” “second,” “third,” “primary,” “secondary,” “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. An armrest assembly of a vehicle, the armrest assembly comprising:
a console configured to be positioned between two neighboring vehicle seats and rotatable about two pivots between a stowed position and a fold-down position;
two wing covers configured to conceal the two pivots from a top side and a front side of the vehicle seats, the two wing covers being positioned between the console and the vehicle seats; and
a charging station configured to receive and charge one or more electrical devices, the charging station being positioned on a top side of the console.

2. The armrest assembly of claim 1, further comprising a locking system, the locking system comprising:
one or more locking pins; and
an actuator assembly, the actuator assembly being configured to move the one or more locking pins between a locked configuration and an unlocked configuration when the console is in the stowed position,
wherein the console is locked in the stowed position when in the locked configuration, and wherein the console is movable between the stowed position and the fold-down position when in the unlocked configuration.

3. The armrest assembly of claim 2, further comprising a release button configured for a user to unlock the console when the console is in the stowed position.

4. The armrest assembly of claim 1, further comprising a storage compartment and a storage lid configured to cover at least a portion of the storage compartment.

5. The armrest assembly of claim 4, wherein the storage lid is releasably latched to the console.

6. The armrest assembly of claim 1, further comprising one or more cupholders positioned on the console.

7. The armrest assembly of claim 2, further comprising an elastic gap hider configured to conceal the locking system from the top side and the front side of the vehicle seats.

8. The armrest assembly of claim 1, wherein the charging station comprises a charging tray positioned on the console and an induction charger unit disposed underneath the charging tray inside the console.

9. The armrest assembly of claim 1, wherein the two neighboring vehicle seats are positioned in a second row of the vehicle.

10. The armrest assembly of claim 1, further comprising a bracket positioned on a back side of the armrest assembly, the two wing covers configured to conceal the bracket from a top side and a front side of the vehicle seats.

11. An armrest assembly of a vehicle, the armrest assembly comprising:
a console configured to be positioned between two neighboring vehicle seats and rotatable about two pivots between a stowed position and a fold-down position; and
two wing covers configured to at least partially conceal the two pivots.

12. The armrest assembly of claim 11, wherein each of the two wing covers comprises a lid configured to hide the pivot from a top side and a front side of the vehicle seats, and a cutout configured to allow the pivot to rotate within and relative to the cover.

13. The armrest assembly of claim 11, further comprising a storage compartment disposed on the console.

14. The armrest assembly of claim 12, further comprising a storage lid configured to cover at least a portion of the storage compartment and releasably latched to the console.

15. The armrest assembly of claim 11, further comprising a bracket, the two wing covers configured to at least partially conceal the bracket.

16. An armrest assembly of a vehicle, the armrest assembly comprising:
a console configured to be positioned between two neighboring vehicle seats and rotatable about two pivots between a stowed position and a fold-down position; and
a charging station configured to receive and charge one or more electrical devices, the charging station being positioned on the console.

17. The armrest assembly of claim 16, wherein the charging station comprises a charging tray positioned on the console and an induction charger unit disposed underneath the charging tray inside the console.

18. An armrest assembly of a vehicle, the armrest assembly comprising:
a console configured to be positioned between two neighboring vehicle seats and rotatable about two pivots between a stowed position and a fold-down position; and
a locking system, the locking system comprising:
one or more locking pins; and
an actuator assembly, the actuator assembly being configured to move the one or more locking pins between a locked configuration and an unlocked configuration when the console is in the stowed position,
wherein the console is locked in the stowed position when in the locked configuration, and wherein the console is movable between the stowed position and the fold-down position when in the unlocked configuration.

19. The armrest assembly of claim 18, further comprising a release button configured for a user to unlock the console when the console is in the stowed position.

20. The armrest assembly of claim 18, further comprising an elastic gap hider configured to at least partially conceal the locking system.
